(19) United States
(12) Patent Application Publication
(10) Pub. No.: US 2012/0307524 A1
(43) Pub. Date: Dec. 6, 2012

(54) LED LAMPHOLDER AND LAMP SYSTEM WITH MEANS TO PREVENT LAMPING OF NONCONFORMING LAMPS

(75) Inventors: Francisco Schapira, Valley Stream, NY (US); Gregory Galluccio, Hauppauge, NY (US); Anthony Tufano, N. Massapequa, NY (US); Carlos Salazar, North Babylon, NY (US); Ruel Sarino, Port Washington, NY (US); Robert Quercia, Garden City, NY (US)

(73) Assignee: Leviton Manufacturing Co., Inc., Melville, NY (US)

(21) Appl. No.: 13/152,873

(22) Filed: Jun. 3, 2011

(51) Int. Cl. H01R 33/00; H01R 13/625

(52) U.S. Cl. 362/652; 439/332

(57) ABSTRACT

A lampholder assembly is provided which includes first and second lampholders. The first lampholder includes first and second electrical connectors for electrically connecting a first end of an LED lamp to a host voltage supply-line and neutral-line, respectively, and preventing improper coupling to the voltage supply-line. The second lampholder includes a first plunger component for coupling to a second end of the LED lamp and cooperating with a second plunger component provided on the second end of the LED lamp for biasing at least one of the first and second plunger components to generate a force for supporting the LED lamp in an installation position. The first lampholder engages the LED lamp only when the LED lamp is oriented in the installation position so that the first and second electrical connectors electrically connect the LED lamp to the voltage supply-line and neutral return-line, respectively, for operating the LED lamp.

### BACKGROUND

1. Technical Field

The present disclosure relates generally to a system and method for preventing installation of a fluorescent lamp in a lampholder that is intended to receive an LED lamp. In particular, the present disclosure relates to a system and method for ensuring proper and safe installation of an LED lamp in an LED lampholder while preventing improper installation of a fluorescent lamp in the LED lampholder.

2. Description of Related Art

LED lamps are becoming more popular due to their advantages over lamps using other lighting technologies. LED lamps excel in energy consumption efficiency, reliability, and length of lifetime. Additional advantages of LED lamps, when compared specifically to fluorescent lamps, include: the lamp has the ability to turn on instantly; the lamp's lifetime is unaffected by cycling on and off, such as when powered on and off during normal usage; the lamp's electrical components are securely mounted and are thus more durable; and the lamp is housed in a strong plastic material rather than glass.

Conventional fluorescent lampholders have been widely used and are currently installed in many host structures, e.g., residential houses or commercial buildings. Conventional fluorescent lamps and lampholders include, for example, G5 and G13 bases, using T5, T8, or T12 lamp tubes. The fluorescent lampholders are typically mounted into a fixture that is mounted to a wall or ceiling of the host structure. The fixture may be embedded in the wall or ceiling. In lieu of the recent popularity of LED lamps shaped like T8 or T5 fluorescent tubes, existing fluorescent fixtures are frequently retrofitted for accepting self-ballasted LED lamps while leaving the lampholder and fixture intact. This can be economically favorable as compared to removing and replacing the entire fixture.

The retrofitting may include removing or bypassing one or more electrical devices that are required for operating fluorescent lamps, such as a ballast, and coupling the lampholder to branch circuitry of a host electrical system of the host structure. Once a fixture has been retrofitted for accepting an LED lamp to be installed therein, installation of a conventional fluorescent lamp in the lampholder(s) should be prevented.

A person performing a lamp replacement may not be aware that the fixture has been retrofitted to receive an LED lamp. Installation of a fluorescent lamp in a fluorescent lampholder that has been rewired to accept self-ballasted LED lamps would result in direct coupling of the fluorescent lamp to the branch circuitry, without the required ballast, posing a danger, to the host electrical system, the host structure, a person nearby, the lampholder, and/or the lamp.

In addition, once a fluorescent lampholder has been rewired to receive an LED lamp, the lampholder still may not be suitable to receive certain types of LED lamps. First, many LED lamps are considerably heavier than fluorescent lamps, sometimes three times heavier. A standard fluorescent lampholder may not be designed to hold the weight of an LED lamp. The danger of the lampholder's insufficient weight capacity increases when the lampholder is subject to vibrations or impact, such as when mounted below a ceiling that is subject to vibrations from above, e.g., foot or moving vehicle traffic, or to impact from below, e.g., from an object, such as a ball.

Additional dangers exist due to the different construction of the fluorescent and LED lamps. LED lamps are formed by materials that are more apt to expand or contract in response to temperature changes than the materials used to manufacture fluorescent lamps. An LED lamp supported by a lampholder that is not designed to compensate for a change in fluorescent lamp length may either drop out of the lampholder due to lamp contraction, or break while installed in the lampholder due to lamp expansion.

When the retrofit includes rewiring of the lampholder connections, it may create an unknown hazard that could include the danger of electric shock or fire. The majority of existing fluorescent lampholders have been provided with an internal shunt to allow two pins at one end of an installed lamp to be connected in common. This connection is typical for “instant-start” type fluorescent ballasts. This can create an unknown hazard, because markings or labels that indicate that the lampholder includes an internal shunt may or may not be provided on the back of the lampholder and, if provided, may not be visible once the lampholder is installed. The only way to positively determine that a lampholder is internally shunted is by electrically testing it.

If a fixture is rewired as part of an LED retrofit, and the line and neutral connections are brought to the terminals of an internally shunted lampholder, a short-circuit across the branch circuit conductors may result, posing a severe potential hazard. UL has posted public warnings that are currently active on UL's website regarding potential hazards in retrofitted fixtures with lampholders that have internal shunts. A further danger exists when the internal contacts of a fluorescent lampholder are configured to be coupled to a supply voltage-line and a return neutral-line, respectively. If these two lines are spaced physically too closely together, arcing may result, posing a danger of shock or fire.

Finally, some self-ballasted LED lamps require a lampholder conductor to be coupled to the supply voltage-line at one side of the fixture and a lampholder conductor coupled to the return neutral-line at the other side. It is foreseeable that an LED lamp may be installed by first coupling a first end of the lamp to the supply voltage-line, followed by coupling the other end of the lamp to the return neutral-line. However, once the first end of the lamp is coupled to the supply voltage-line, the other end of the lamp may become electrically live and pose a serious danger to the person installing the lamp, as they can easily come in contact with the exposed electrically live component.

Thus there is a need for a system and method for ensuring proper and safe installation of an LED lamp in an LED lampholder while preventing improper installation of a fluorescent lamp in the LED lampholder.

### SUMMARY

The present disclosure is directed to a lampholder assembly which includes a first and second lampholder. The first lampholder includes a first electrical connector adapted and configured to couple and electrically connect a first end of an LED lamp to a voltage supply-line of a host electrical system. The second electrical connector is adapted and configured to couple and electrically connect the first end of the LED lamp to a neutral return-line of the host electrical system and to prevent improper coupling to the voltage supply-line.

The second lampholder includes a first plunger component adapted and configured to couple to a second end of the LED lamp. The first plunger component is further adapted and configured to cooperate with a second plunger component provided on the second end of the LED lamp for biasing at least one of the first and second plunger components to generate a force for supporting the LED lamp in an installation position. The first lampholder is adapted and configured to engage the LED lamp only when the LED lamp is oriented in the installation position so that the first and second electrical connectors electrically connect the LED lamp to the voltage supply-line and the neutral return-line, respectively, for operating the LED lamp.

The present disclosure is also directed to a lampholder assembly including a first and second lampholder. The first lampholder includes a first electrical connector adapted and configured to couple and electrically connect a first end of an LED lamp to a voltage supply-line of a host electrical system. The second electrical connector is adapted and configured to couple and electrically connect the first end of the LED lamp to a neutral return-line of the host electrical system.

The lampholder assembly further includes a structural rejection feature extending from the first lampholder, wherein the rejection feature is adapted and configured to physically interfere with electrically connecting the LED lamp with the host electrical system unless the LED lamp has a structural cooperating rejection feature adapted and configured for accommodating the structural rejection feature. The second lampholder engages a second end of the LED lamp. The first lampholder is adapted and configured to engage the LED lamp only when the LED lamp is oriented in an installation position in which the structural cooperating rejection feature of the LED lamp accommodates the structural rejection feature of the first lampholder, and in which the first and second electrical connectors electrically connect the LED lamp to the voltage supply-line and the neutral return-line, respectively, for operating the LED lamp.

The present disclosure is further related to an LED lamp including a housing provided with a first and second end, plurality of LED elements disposed within the housing; and an electrical circuit electrically for coupling to the LED elements. The first end includes a first electrical connector adapted and configured to couple and electrically connect the electrical circuit to a voltage supply-line of a host electrical system via a first lampholder electrically connected to the voltage supply-line. The first end further includes a second electrical connector adapted and configured to couple and electrically connect the electrical circuit to a neutral return-line of the host electrical system via the first lampholder. The second electrical connector is adapted and configured to prevent improper coupling to the voltage supply-line.

The second end includes a first plunger component adapted and configured to couple to a second lampholder. The first plunger component is adapted and configured to cooperate with a second plunger component provided on the second lampholder for biasing at least one of the first and second plunger components to generate a force for supporting the LED lamp in an installation position in which the first and second electrical connectors electrically connect the LED lamp to the voltage supply-line and the neutral return-line, respectively, for operating the LED lamp. The LED lamp is adapted and configured to be engaged by the first lampholder only when the LED lamp is oriented in the installation position.

Other features of the presently disclosed LED lamp and LED lampholder will become apparent from the following detailed description, taken in conjunction with the accompanying drawings, which illustrate, by way of example, the presently disclosed LED lamp and LED lampholder.

### BRIEF DESCRIPTION OF THE DRAWINGS

Various embodiments of the present disclosure will be described below with reference to the figures, wherein:

FIG. 1 is a schematic diagram of an LED lamp assembly in accordance with the present disclosure;

FIG. 2 is a perspective end view of a first exemplary embodiment of an LED lamp and an LED lampholder in accordance with the present disclosure;

FIG. 3 is a perspective side view of a second exemplary embodiment of an LED lamp and an LED lampholder with the LED lamp being installed in the LED lampholder in accordance with the present disclosure;

FIG. 4 is a perspective end view of the LED lamp and the LED lampholder with the LED lamp installed in the LED lampholder in accordance with the embodiment shown in FIG. 3;

FIG. 5 is a perspective side view of a first exemplary embodiment of a support type LED lampholder for engaging a second end of the LED lamp in accordance with the present disclosure;

FIG. 6 is a perspective end view of the second end of the LED lamp installed within the LED lampholder in accordance with the embodiment shown in FIG. 5;

FIG. 7 is a perspective side view of a second exemplary embodiment of a support type LED lampholder for engaging the second end of the LED lamp in accordance with the present disclosure;

FIG. 8 is a perspective side view of an LED lamp and a perspective end view of an LED lampholder in accordance with an exemplary third embodiment of the LED lamp assembly in accordance with the present disclosure; and

FIG. 9 is a perspective side view of the LED lamp installed in the LED lampholder in accordance with the present disclosure.

### DETAILED DESCRIPTION

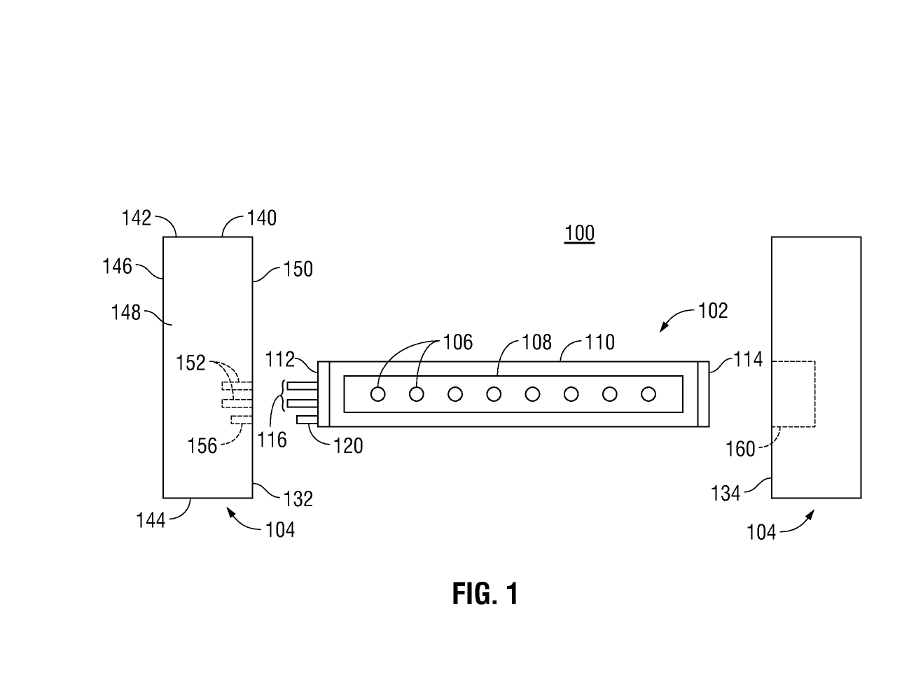

Referring now to the drawing figures, in which like reference numerals identify identical or corresponding elements, the LED lamp assembly and method in accordance with the present disclosure will now be described in detail. With initial reference to FIG. 1, an exemplary LED lamp assembly in accordance with the present disclosure is illustrated and is designated generally as LED lamp assembly 100.

LED lamp assembly 100 includes an LED lamp 102 and a lampholder set 104. The LED lamp 102 and lampholder set 104 are configured for the LED lamp 102 to be installed in the lampholder set 104, including to be physically held by the lampholder set 104 and electrically coupled to the lampholder set 104 for enabling the LED lamp 102 to generate light. The LED lamp 102 includes a plurality of LED elements 106 and an electrical assembly 108 that includes, for example, a printed circuit board, electrical components, etc. The LED elements 106 and electrical assembly 108 are housed within a translucent housing 110 having first and second ends 112 and 114, respectively. The housing 110 may be a long, hollow cylinder formed at least partially of a material that is capable of transmitting light, such as plastic. When the LED lamp 102 is operated, the electrical assembly 108 is powered and controls the LED elements 106 to illuminate.

First and second ends 112, 114 may each be provided with caps. The caps may be integral to the housing 110 or may be attached to the housing 110 by any means now known or hereafter developed including for example by a screw fit, a snap fit, a heat treatment and/or an epoxy. The LED lamp 102 is provided with at least two electrical connectors 116. In the embodiment shown, both electrical connectors 116 are provided at the cap of the first end 112, however, in another embodiment an electrical connector 116 may be provided at each of the ends 112 and 114. One of the at least two electrical connectors 116 is configured to connect with a voltage supply-line and another to a neutral return-line, e.g., that are included with the branch circuitry. The LED lamp 102 may further be provided with a physical lamp rejection feature 120. In the embodiment shown the rejection feature 120 is a lip that extends from the bottom of the cap of first end 112. However alternatively shaped rejection features are envisioned.

Lampholder set 104 is installed in a fixture which is then installed in a host structure, such as a residential or commercial building. Installation typically includes structurally coupling the lampholder set 104 to a sub-structure, such as a ceiling or wall of the host structure via a fixture that is mounted to the sub-structure. The fixture may be originally designed for fluorescent lighting, e.g., for supporting fluorescent lampholders that are configured to couple structurally and electrically with a fluorescent lamp as would be readily understood by one of ordinary skill in the art.

Installation further includes electrically coupling the lampholder set 104 to an electrical system of the host structure, such as via a branch circuit. The branch circuit is a sub-circuit of the electrical system that extends between an electrical panel, circuit breaker, or fuse of the electrical system. In the present embodiment, the lampholder set 104 is directly connected to the branch circuit. The electrical system may be a home or building electrical system that includes, for example, a main panel, a main circuit breaker, branch circuits, etc., which receives a current supply from a utility company. Alternatively, the electrical system may be supplied power by a DC power supply source, such as a battery. Another configuration may include connecting the fixture to a DC electrical system within a building where the lampholder set 104 is connected directly to the DC output of a voltage converter that is part of the host structure electrical system. Electrical installation associated with the retrofitting of a fluorescent fixture to operate with LED lamps may further include removing or bypassing electrical wiring used specifically for operating a fluorescent lamp, such as a ballast.

Lampholder set 104 includes first and second lampholder 132 and 134, respectively, for coupling structurally with the LED lamp's first and second ends 112 and 114, respectively. Lampholders 132 and 134 may be substantially similar or may be substantially different, depending on the embodiment, as described in greater detail below. At least one of lampholders 132 and 134 is configured for electrically coupling with the LED lamp 102. Each lampholder may provide some amount of physical support to the LED lamp 102. In one embodiment shown in FIG. 1, the first lampholder 132 preferably structurally couples with first end 112 of the LED lamp, providing a relatively small amount of physical support to lamp 102, and further electrically couples with the LED lamp 102, wherein the second lampholder 134 preferably structurally couples with second end 114 of the LED lamp, providing a relatively large amount of physical support to LED lamp 102 but without electrically coupling to the LED lamp 102.

Each of the lampholders 132 and 134 preferably includes a housing 140 that is configured structurally to be mounted to the fixture. In the situation where the fixture was originally designed for fluorescent lighting, the outer shape of the housing 140, including its top wall 142, bottom wall 144, back wall 146, and side walls 148, may be configured similar to that of a fluorescent lampholder. However, with respect to at least one of the first and second lampholders 132 and 134, the housing's front wall 150 and the lampholder's 132, 134 internal structure are different than that of a fluorescent lampholder and at least one of the lampholders 132, 134 preferably includes at least one feature to reject insertion of a fluorescent lamp.

With reference to first lampholder 132, the housing 140 is provided with electrical connectors 152 for receiving each of the electrical connectors 116. One of the connectors 152 is electrically coupled to the voltage supply-line of the branch circuit included with the electrical system of the host structure. Another one of the connectors 152 is electrically coupled to the neutral return-line of the branch circuit. Others connectors 152 may be provided to couple to the electrical circuitry that is associated with providing additional operational features associated with the LED lamp, such as dimming. The configuration of the connectors 116, such as the size and spacing of the connectors 116, may provide a rejection feature. An additional rejection feature, lampholder rejection feature 156, may be provided that mates with the lamp rejection feature 120 for allowing installation of the LED lamp 102 but rejecting a lamp, such as a fluorescent lamp, that is not provided with the lamp rejection feature 120.

With respect to the second lampholder 134, a support feature 160 is provided that provides relatively strong support to lamp 102. A variety of support features 160 are envisioned including but not limited to a clamp, clip, hook, rotate and lock device, or plunger. Where suitable, it may be possible to provide a support feature 160 at both lampholders 132 and 134. Also, where suitable, a cooperating support feature may be provided at one or more of the ends 112, 114 to cooperate with support feature 160.

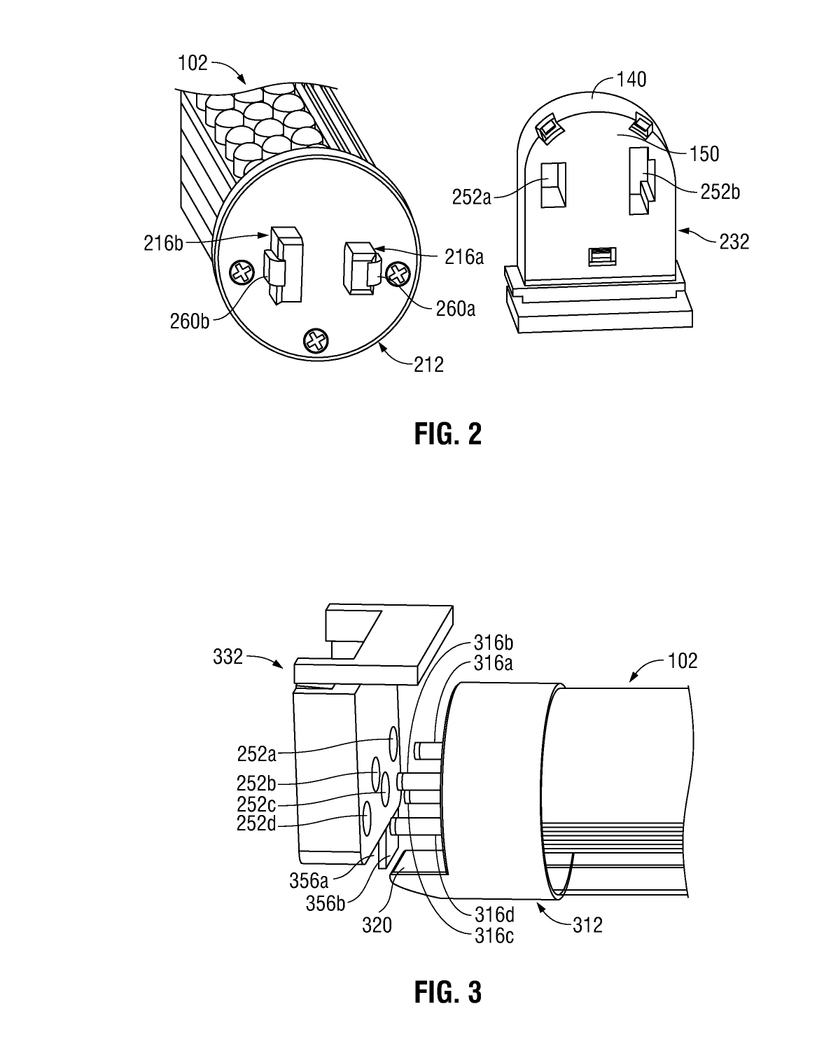

With reference to FIG. 2, a second embodiment of a first end 212 of lamp 102 and a first lampholder 232 of LED lamp assembly 100 is shown. First end 212 of lamp 102 and first lampholder 232 are embodiments of the first end 112 of lamp 102 and the first lampholder 132 shown in FIG. 1, respectively. First end 212 is provided with a pair of male electrical connectors 216a and 216b. Each electrical connector 216a, 216b includes a conductor formed of a conductive material that electrically couples to the electrical assembly 108 and is further exposed for electrically coupling to another electrical conductor. Furthermore, each electrical connector 216a, 216b may include a resilient member 260a and 260b.

First lampholder 232 includes a pair of female electrical connectors 252a and 252b formed as apertures that are sized and shaped, respectively, to receive connectors 216a and 216b. Connectors 252a and 252b are each provided with an internal electrical conductor (not shown). One internal electrical conductor is electrically coupled to the branch circuit's voltage supply-line and the other internal electrical conductor is electrically coupled to the neutral return-line of the branch circuit. When connectors 216a and 216b are inserted into the respective connectors 252a and 252b, the resilient characteristic of the associated resilient members 260 allows them to be compressed, and a slanted or curved front end, may allow them to slide into the respective connector 252a and 252b.

Once inserted, each connector 216a and 216b physically and electrically couples to the internal conductor associated with the receiving connector 252a and 252b. While inserted, the resilient members 260 are at least partially compressed, exerting a biasing force so that each conductor of connectors 216a and 216b is pressed against the associated internal conductor, thus making a good stable physical and electrical contact.

The mating connector/connector pairs 216a/252a and 216b/252b are preferably keyed, meaning that they have two different shapes, which accomplishes three functions. First, the first end 212 has to be oriented so that the connectors 216a, 216b are inserted into the proper connectors 252a and 252b, which achieves safe and proper polarization and electrical conduction. Second, the shapes and sizes of connectors 252a and 252b make it visually apparent that the first lampholder 232 is not configured for installation of a fluorescent lamp. Third, the connectors 252a and 252b are not configured for accepting a pin or pin pair of a fluorescent lamp, and thus the shape, size and/or spacing of the connectors 252a and 252b serve as a rejection feature that prevents installation of a fluorescent lamp.

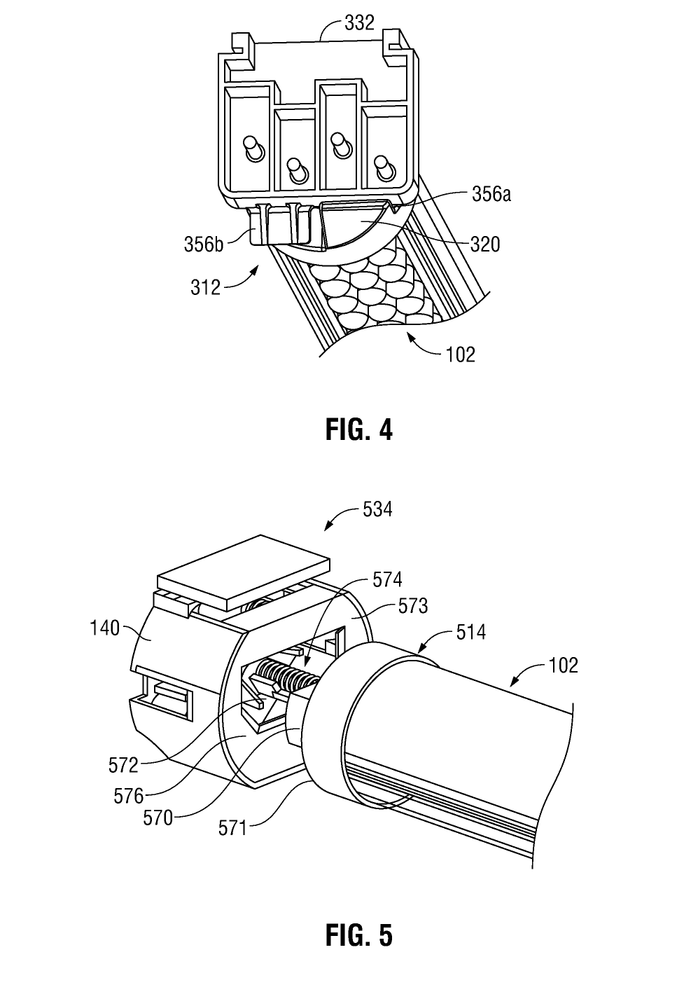

FIGS. 3 and 4 show a third embodiment of a first end 312 of lamp 102 and a first lampholder 332 of LED lamp assembly 100. First end 312 of lamp 102 and first lampholder 332 are embodiments of the first end 112 of lamp 102 and the first lampholder 132 shown in FIG. 1, respectively. First end 312 is provided with a plurality of at least three electrical connectors 316a-316d that are shaped as elongated pins. While four connectors 316a-316d shaped as pins are illustrated, the disclosure is not limited to four connectors or to a pin shape. Any number of two or more connectors is envisioned, and the connectors may be shaped or packaged in a variety of ways, such as differently dimensioned pins, flat contacts, bump-out contacts, etc.

The connectors 316a-316d are received by connectors 352a-352d, respectively, which are formed as apertures provided in first lampholder 332. Connectors 352a-352d are sized, shaped and positioned for receiving or mating with connectors 316a-316d. Furthermore, each connector 352a-352d is provided with an internal electrical conductor (not shown) that couples to electrical circuitry. Such electrical circuitry may include branch circuitry and may further include electrical circuitry for operating one or more operational features associated with operating the lamp 102, such as a color controller, a dimmer, a timer, a controller responsive to an ambient light sensor, etc.

Two of the connectors 316a-d are configured for coupling to a voltage supply-line and a neutral return-line, respectively. The other pins are configured for coupling to the electrical circuitry for operating one or more operational features associated with LED lamp 102. When the connectors 316a-d are received within connectors 352a-352d, connectors 316a-316d mate electrically with the appropriate internal conductors received in the connectors 352a-352d.

The connectors 352a-352d are not sized, shaped, or positioned for receiving electrical connectors from a fluorescent lamp. The configuration of the connectors 352a-352d accomplishes three functions. First, in order for three or more connectors 316a-316d to be inserted in the appropriate connectors 352a-352d, the first end 312 has to be properly oriented, achieving safe and proper polarization and electrical conduction. For example, the connectors 352a-352d can be positioned so that the lamp 102 cannot be installed upside down. Second, due to the number, shapes and sizes of connectors 352a-352d, it is visually apparent that the first lampholder 332 is not configured for installation of a fluorescent lamp. Third, the connectors 352a-352b are not configured for accepting a pin or pin pair of a fluorescent lamp, and thus the shape, size and/or spacing of the connectors 352a-352b serve as a rejection feature that prevents installation of a fluorescent lamp.

First end 312 is further provided with a structural male orientation feature 320 configured as a projection that is shaped to be received by structural female orientation feature 356a provided at the first lampholder 332. The purpose of this feature is to orient the LED lamp 102 such that the LED's are always facing away from the fixture base. Male orientation feature 320 structurally prevents LED lamp 102 from being installed into a lampholder set 104 in any orientation other than that intended by the lamp design. The shape of the female orientation feature 356a is defined at least partially by orientation feature wall 356b. The shape of the male and female orientation features 312 and 356a and wall 356b may be reconfigured for different models of LED lamp 102 which may have different electrical configurations, feature capabilities and/or voltage or current needs.

While the configurations in FIGS. 1-4 show rejection features in which a male-type projection provided on the embodiments of first end 112, 212, or 312 of the lamp 102 mates with a female-type rejection feature provided on the embodiments of first lampholder 132, 232, or 332, the disclosure is not limited thereto. The first lampholder may be provided with a male-type rejection feature that mates with a female-type rejection feature provided on the first end of the lamp. This has the advantage of preventing installation of a non-compatible lamp that is free of projecting rejection features, such as a fluorescent lamp.

While the configurations in FIGS. 1-4 show mating electrical connectors, with male-type connectors provided on the embodiments of first end 112, 212, or 312 of the lamp 102 that mate with female-type connectors provided on the embodiments of first lampholder 132, 232, or 332, the disclosure is not limited thereto. The first lampholder may be provided with male-type connectors that mate with female-type connectors provided on the first end of the LED lamp 102. This is true as well for LED lamps 102 that have electrical connectors at both ends.

When installed, the structural coupling of the embodiments of the first end of LED lamp 102 shown in embodiments of FIGS. 2-4 with the first lampholder provides some physical support for LED lamp 102. However, the LED lamp 102 may be relatively heavy (up to approximately 1.5 lb), particularly when compared with a standard linear fluorescent lamp (approximately 7 oz.). The weight of a fluorescent lamp is thus about one third the weight of the LED lamp 102. Additionally, the LED lamp assembly 100 may be installed in an environment where it is subject to significant vibrations, such as when installed at a roadside or in a gym. The LED lamp assembly 100 not only must support a relatively heavy lamp, but it may need to withstand vibrations caused by events, such as the passing of a heavy truck or impact of a basketball. Additionally, the LED lamp 102 may be subject to different temperature conditions. The materials used to form the LED lamp 102 are relatively sensitive to temperature changes and may expand or contract in response. Adequate support is needed for the relatively large weight of LED lamp 102, particularly when subjected to vibrations or temperature changes that may cause the LED lamp 102 to expand or contract.

FIGS. 5-7 show two exemplary embodiments of plunger arrangements provided at a second lampholder 534 and a second side 514 of LED lamp 102 that give relatively strong support to the LED lamp 102. The support is sufficient to hold the LED lamp's 102 weight, including when the LED lamp 102 is subject to vibrations or changes in temperature conditions that cause the LED lamp 102 to expand or contract. First end 514 of lamp 102 and first lampholder 534 are embodiments of the second end 114 of lamp 102 and the second lampholder 134 shown in FIG. 1, respectively. Other embodiments are envisioned in accordance with design choice, such as providing one lampholder or both lampholders with a plunging member that is received and held at one or more corresponding ends of the LED lamp 102 when installed. The plunger member or structure for receiving the plunger member may further be provided at any of the lampholders or ends of LED lamp 102 that has an electrical connector structure.

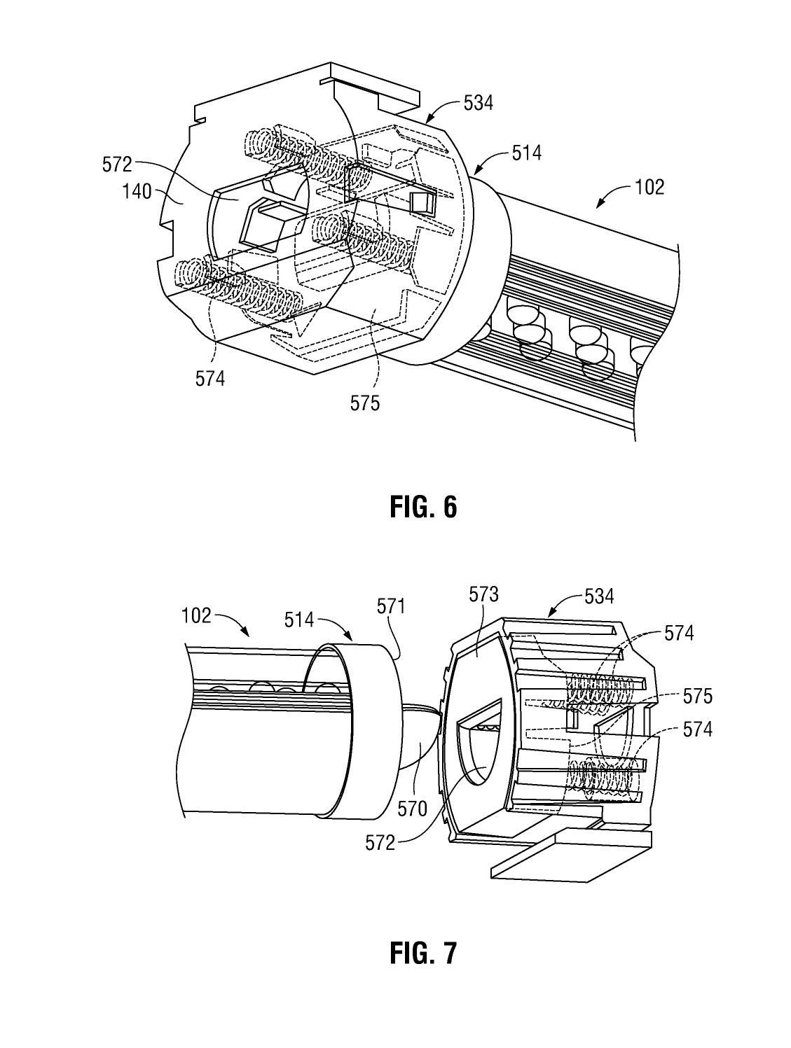

FIGS. 5-6 show a first embodiment of a plunger arrangement in which second end 514 is provided with an extending plunging member 570 that is received and held securely by second lampholder 534. A biasing force produced by springs provided within the second lampholder 534 provides the secure hold. Second end 514 of LED lamp 102 has a front face 571 that faces the second lampholder 534. Plunger member 570 extends from the front face 571. Second lampholder 534 has a movable annular member 576 that has a front face 573 and opposing back face 575. When installing LED lamp 102, front face 573 faces front face 571 of the second end 514 of the LED lamp 102. Front face 573 is provided with at least one opening 572 defined by the annular member 576 for receiving plunger member 570. Behind annular member 576 are one or more springs 574. The springs 574 are mounted within second lampholder 534, e.g., to an inner face of a back wall of second lampholder 534. A front end of the springs 574 physically contacts the back face 575 of the annular member 576, particularly when the annular member 576 is pushed against the springs 574, as described further below.

When the LED lamp 102 is installed in lampholder set 104, e.g., in position and ready for use, plunger member 570 is inserted in the opening 572 of annular member 576. Front face 573 pushes against front face 571 causing annular member 576 to move in a backward direction. This movement may be a sliding movement and structures may be provided to direct the movement and keep the annular member 576 on track. Back face 575 pushes against springs 574 causing them to compress. While the springs 574 are compressed, the first end (e.g., the embodiments 112, 212, or 312, as shown in FIGS. 1-3) can be installed in the first lampholder (e.g., 132, 232, or 332).

Once the first end of the LED lamp 102 is installed, the springs 574 may partially decompress, still pushing against the back face 575. However, the length of LED lamp 102 and the spacing of the first and second lampholders of the lampholder set 104 are configured so that the compression members 574 will remain compressed once both ends of LED lamp 102 are installed. The compression exerts a biasing force against front face 571. This biasing force and the insertion of plunger member 570 in opening 572 holds LED lamp 102 firmly in its installed position at both ends of LED lamp 102. This biasing force provides sufficient support for holding the LED lamp's weight so that LED lamp 102 remains installed, including withstanding vibrations. Additionally, when the LED lamp 102 expands or contracts, the compression members 574 adjust for the change in length of LED lamp 102 without compromising the support provided.

Plunger member 570 may be integral to or attached to first end 514. It may be shaped in a variety of ways. Springs 574 are shown as compression springs having coils, but other devices for biasing first end 514 in a direction parallel to the longitudinal axis of LED lamp 102.

FIG. 7 shows a different embodiment of the plunger arrangement in which the plunger member 570 and opening 572 have a different shape and there are more compression members 574 than in the embodiment shown in FIGS. 5-6. Other embodiments are envisioned, including reversing the plunger functions of the second end 514 of the LED lamp 102 and the second lampholder 534. This may include providing the second lampholder 534 with the plunger member 570 and the second end 514 of LED lamp 102 with the means for receiving and securely holding the plunger member 570 while supporting the LED lamp 102.

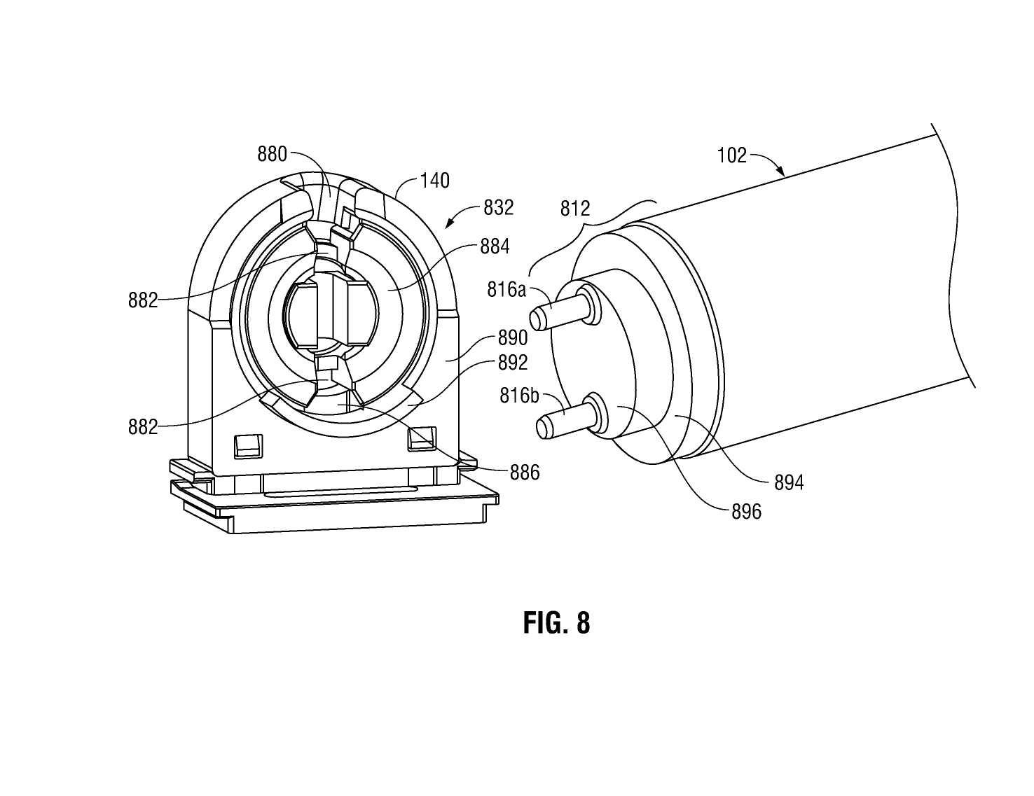

FIG. 8 shows a fourth embodiment of a first end 812 of LED lamp 102 and a mating first lampholder 832. First end 812 of lamp 102 and first lampholder 832 are embodiments of the first end 112 of lamp 102 and the first lampholder 132 shown in FIG. 1, respectively. The first end 812 is provided with a pair of pins 816a and 816b. Pins 816a and/or 816b may include an electrical connector for electrically coupling to a corresponding internal electrical conductor (not shown) provided within first lampholder 832. One or more internal electrical conductors may be provided which are electrically coupled to the voltage supply-line and/or the neutral return-line.

The pins 816a and 816b are inserted into the first lampholder 832 via aperture 880 provided in housing 140. The pins 816a and 816b are aligned so that they can be received in slots 882 provided in rotating ring 884 which rotates about an annular track 886. Rotating ring 884 may be rotated into a locked position when the LED lamp 102 is rotated. When the pins 816a and 816b are received in slots 882, they may be at least partially supported, e.g., by annular track 886. Once in the locked position, the pins 816a and 816b couple electrically to the internal conductor(s). This allows the LED lamp 102 to operate electrically and holds the LED lamp 102 in a relatively secure installed position. Exemplary lamp assemblies having a rotate and lock mechanism are described in U.S. patent application Ser. No. 13/014,972, entitled “LAMP SOCKET HAVING A ROTOR ASSEMBLY,” filed on Jan. 27, 2011; U.S. patent application Ser. No. 12/985,768, entitled “LAMP SOCKET HAVING A ROTOR,” filed on Jan. 6, 2011; and U.S. patent application Ser. No. 12/243,509, entitled “LAMP SOCKET HAVING A ROTOR ASSEMBLY,” filed on Oct. 1, 2008, wherein the entire contents thereof are incorporated herein by reference.

First lampholder 832 and first end 812 are provided with an inner face 890 and outer face 894, respectively, which face one another when the LED lamp 102 is installed in the LED lampholder set 104. The inner face 890 of first lampholder 832 is provided with a projection or flange, shown in the current example as lip 892 that extends away from inner face 890, which acts as a rejection feature. The projection extends from the inner first face 890 for preventing installation of a lamp that does not have a cooperating rejection structure, but that also may provide support to the LED lamp 102 once installed in the lampholder set 104 or during installation, or guide the LED lamp 102 when it is rotated, or at least not interfere with the rotation. A typical linear fluorescent lamp cannot be installed in lampholder set 104 because lip 892 would prevent any pins or electrical connectors from being a) inserted into the first lampholder 832, b) received in slots 882, c) electrically coupled to any internal conductors, and/or would further prevent the lamp from assuming or locking into a position for proper electrical operation and/or secure positioning.

The second end (not shown) of the LED lamp 102 and the second lampholder (not shown) of the lampholder set 104 are configured substantially similarly to the first end 812 and first lampholder 832, respectively. More specifically, the second end is provided with a pair of pins 816a and 816b. The second lampholder is provided with aperture 880 provided in housing 140, and slots 882 provided in rotating ring 884 for receiving and holding pins 816a and 816b. When the pins 816a and 816b are received in slots 882 they may be at least partially supported, e.g., by annular track 886, thus providing at least partial support for LED lamp 102. The second lampholder may include one or more internal conductors which are electrically coupled to the voltage supply-line and/or the neutral return-line so that once both ends of the LED lamp 102 are installed in the lampholder set 104 the LED lamp 102 is properly coupled to the voltage supply-line and neutral return-line.

A variety of electrical configurations are envisioned. In one embodiment, the LED lamp 102 and lampholder set 104 are configured so that the LED lamp 102 is coupled via the pins 816a and 816b provided at the first end 812, only, to the voltage supply-line and the neutral return-line via internal conductors provided at the first lampholder 832. The pins 816a and 816b provided at the second end may not be electrically coupled to the LED lamp 102 and the second lampholder of the lampholder set 104 may not include internal conductors. This embodiment eliminates the risk of the second end of the LED lamp 102 or the second lampholder of the lampholder set 104 from posing a danger when electrically live and exposed to contact by a careless or unaware person once the first end of the lamp is coupled to the supply voltage-line. An alternative safe arrangement includes providing pins 816a and 816b at both ends of LED lamp 102 for control purposes, wherein the supply voltage is supplied at a non-hazardous level.

In another embodiment, pin 816a of the first lampholder 832 is configured for coupling to the voltage supply-line. Pin 816b may be tied to pin 816a so that they act as one pin, or it may be electrically isolated from pin 816a and electrical components of the LED lamp 102 and first lampholder 832.

The outer face 894 of first end 812 is provided with a pin platform 896 upon which the pins 816a and 816b are mounted. The pin platform 896 is sized and cylindrically shaped to adapt to the lip 892 so that pins 816a and 816b can be received in opening 880 and both of slots 882 without the pin platform 896 physically contacting lip 892. Even though outer face 894 may physically contact the lip, the pin platform 896 does not. The pins can still electrically couple to the host electrical system for operation of the LED lamp 102, and the first end 812 of the LED lamp 102 can be supported by first lampholder 832 and locked in place.

When the LED lamp 102 is installed into the LED lampholder set 104 and rotated (once the pins 816a and 816b are received in opening 880 and slots 882) the lip 892 does not interfere with rotation of the pin platform 896. Lip 892 has a curvature that complements and is slightly larger than the curvature of pin platform 896, so that pin platform 896 can be positioned to sit on or right above the lip 892 and rotate while in that position. Curvature here refers to the shape of the curve of the lip 892, which may be defined, for example, as the change in inclination of a tangent to a curve over a unit length of the arc. The lip 892 may provide support to the pin platform 896 and/or additional support for LED lamp 102 when it is installed in LED lampholder set 104. The rejection feature, e.g., the lip 892 and cooperating pin platform 896, may be provided at one or both ends of LED lamp 102 and both lampholders of lampholder set 104, respectively.

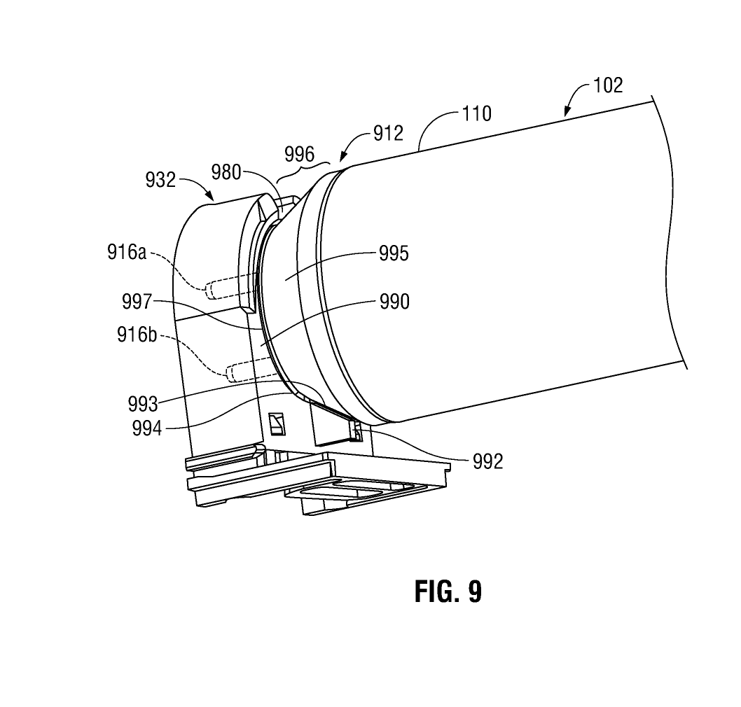

FIG. 9 shows a variation of the embodiment shown in FIG. 8. A first lampholder 932 and a first end 912 of lamp 102 are provided with an opposing inner face 990 and outer face 994, respectively, which face one another. First end 912 of lamp 102 and first lampholder 932 are embodiments of the first end 112 of lamp 102 and the first lampholder 132 shown in FIG. 1, respectively. The inner face 990 of first lampholder 932 is provided with a protruding structure 992, which is similar to protruding structure 892 shown in FIG. 8, except that the shape of its top face 993 is ramped. The first lampholder 932 is also provided with rotating ring 884 having slots 882 for receiving pins 916a and 916b. The rotating ring 884 can lock pins 916a and 916b into their operative positions for enabling electrical operation of LED lamp 102 and for holding the LED lamp 102 in a relatively secure installed position. A fluorescent lamp cannot be installed in lampholder set 104 because protruding structure 992 would prevent any pins or electrical connectors from being inserted into the first lampholder 932 for providing for proper electrical operation and/or secure positioning of LED lamp 102.

First end 912 of LED lamp 102 is provided with a conically shaped cap 996. The cap 996 may be integral to housing 110 or attached to it. Cap 996 has a front face 997 to which pins 916a and 916b are mounted. The cap 996 is size and shaped to adapt to the protruding structure 992 so that pins 916a and 916b can be received in opening 980 and both of slots 882 without the pin platform 996 physically contacting protruding structure 992. Sidewall 995 of the conically shaped pin platform 896 has a slope that is substantially the same as the slope of the slant of the top face 993 of protruding structure 992 so that cap platform 996 can be positioned to sit on or right above the protruding structure 992 and rotated while in that position.

When the LED lamp 102 is rotated, due to the cooperating shapes of protruding structure 992 and cap 996, the protruding structure 992 does not interfere with rotation of the cap 996. The first lampholder 932 receives pins 916a and 916b via opening 980 in housing 140 and slots 882 in rotating ring 884. The protruding structure 992 may provide support to the pin platform 996 and/or additional support for LED lamp 102 when it is installed in LED lampholder set 104. The rejection feature, e.g., the protruding structure 992 and cooperating pin platform 996, may be provided at one or both ends of LED lamp 102 and both lampholders of lampholder set 104, respectively.

While housing 140 in each of the embodiments shown in FIGS. 1-10 can be sized and shaped to fit into an existing base that was originally used for installation of a fluorescent lampholder and lamp, the various rejection features described in the different embodiments will prevent mislamping and the dangers involved.

The rejection features in the embodiments described above reduce the possibility of installation of a fluorescent lamp in an LED lampholder set 104, and may also be used to reduce the possibility of installation of an improperly configured LED lamp. Furthermore, the electrical conductors shown in several of the embodiments are visibly different than those used in conventional fluorescent lamps. This, in addition to the visibility of the structural rejection features provides a visual clue that would warn a person not to attempt the installation. Additionally, the plunger system provided in at least one end of some of the above embodiments generates a biasing force that is capable of compensating for the additional weight of the LED lamp 102 relative to a conventional fluorescent lamp. These plunger systems also are capable for compensating for contraction and expansion of the LED lamp 102 in response to temperature changes.

The present disclosure further provides a method for retrofitting a fluorescent lamp assembly that operates with a fluorescent lamp to operate with an LED lamp, such LED lamp 102. The fluorescent lamp assembly includes a fluorescent lamp, a ballast electrically coupled to the fluorescent lamp and to a host electrical system, and a lampholder set having at least one lampholder for supporting the fluorescent lamp and electrically coupling the fluorescent lamp to the ballast. The method includes accessing the fluorescent lamp assembly and decoupling the ballast from the fluorescent lamp assembly, such as by removing the ballast or bypassing the ballast. The method further includes removing or bypassing the fluorescent lampholder set and installing an LED lampholder set 104 that includes at least a first and second lampholder for supporting an LED lamp 102. At least one of the first and second lampholders have circuitry for coupling the LED lamp 102 to the electrical system. The first and second lampholders may be configured in accordance with the embodiments described above, including first and second lampholders 132 and 134; first lampholder 232; first lampholder 332; second lampholder 534; and first lampholder 832. The lampholder set 104 is configured to reject fluorescent lamps and to properly, securely, and safely support LED lamp 102 and to properly, securely, and safely couple the LED lamp 102 to the host electrical system.

It will be appreciated that features of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A lampholder assembly comprising:
a first lampholder including:
a first electrical connector adapted and configured to couple and electrically connect a first end of an LED lamp to a voltage supply-line of a host electrical system; and
a second electrical connector adapted and configured to couple and electrically connect the first end of the LED lamp to a neutral return-line of the host electrical system, the second electrical connector being adapted and configured to prevent improper coupling to the voltage supply-line; and
a second lampholder including:
a first plunger component adapted and configured to couple to a second end of the LED lamp, the first plunger component being adapted and configured to cooperate with a second plunger component provided on the second end of the LED lamp for biasing at least one of the first and second plunger components to generate a force for supporting the LED lamp in an installation position;
wherein:
the first lampholder is adapted and configured to engage the LED lamp only when the LED lamp is oriented in the installation position so that the first and second electrical connectors electrically connect the LED lamp to the voltage supply-line and the neutral supply-line, respectively, for operating the LED lamp.

2. The lampholder assembly according to claim 1, wherein the first and second electrical connectors are positioned for coupling to and electrically connecting with the LED lamp only when the LED lamp is oriented in the installation position.

3. The lampholder assembly according to claim 1, wherein the first and second electrical connectors have respective first and second different shapes.

4. The lampholder assembly according to claim 1, wherein:
the first electrical connector has a first shape which is shaped for mating with a third electrical connector which is provided at the first end of the LED lamp and is electrically coupled to an electrical circuit of the LED lamp for operating LED elements of the LED lamp;
the second electrical connector has a second shape which is shaped for mating with a fourth electrical connector which is provided at the first end of the LED lamp and is electrically coupled to the electrical circuit of the LED lamp for operating the LED elements of the LED lamp; and
the first and third electrical connectors and the second and fourth electrical connectors can mate only when the LED lamp is oriented in the installation position.

5. The lampholder assembly according to claim 1, wherein the lampholder assembly cannot couple to or electrically connect with a conventional fluorescent lamp.

6. The lampholder assembly according to claim 1, further comprising at least a fifth electrical connector provided at the first lampholder for coupling to the first end of the LED lamp, wherein the fifth electrical connector is further adapted and configured for electrically coupling to at least one external electrical component for providing an additional operational feature associated with the LED lamp.

7. The lampholder assembly according to claim 6, wherein the first, second, and at least fifth electrical connectors are adapted and configured for preventing the LED lamp from being installed in the LED lampholder assembly unless the LED lamp is oriented in the installation position.

8. The lampholder assembly according to claim 6, wherein the additional operational feature is selected from the group of operational features consisting of: a light dimming feature, a light sensing feature, a color control feature, a timing control feature, and an automatic switch feature.

9. The lampholder assembly according to claim 1, wherein the first lampholder is provided with a first structural rejection feature that is adapted and configured to cooperate with a second structural rejection feature provided at the first end of the LED lamp, wherein the first rejection feature is required for the first lampholder to engage the lamp.

10. The lampholder assembly according to claim 1, wherein the lampholder assembly is adapted and configured for installation in a conventional fluorescent fixture in which a conventional fluorescent lampholder assembly was previously installed.

11. The lampholder assembly according to claim 10, wherein a conventional fluorescent lamp lacks a structural rejection feature and cannot be installed in the lampholder assembly for electrically operating the LED lamp.

12. A lampholder assembly comprising:
a first lampholder including:
a first electrical connector adapted and configured to couple and electrically connect a first end of an LED lamp to a voltage supply-line of a host electrical system; and
a second electrical connector adapted and configured to couple and electrically connect the first end of the LED lamp to a neutral return-line of the host electrical system;
a structural rejection feature extending from the first lampholder, wherein the rejection feature is adapted and configured to physically interfere with electrically connecting the LED lamp with the host electrical system unless the LED lamp has a structural cooperating rejection feature adapted and configured for accommodating the structural rejection feature; and
a second lampholder for engaging a second end of the LED lamp wherein:
the first lampholder is adapted and configured to engage the LED lamp only when the LED lamp is oriented in an installation position in which the structural cooperating rejection feature of the LED lamp accommodates the structural rejection feature of the first lampholder, and the first and second electrical connectors electrically connect the LED lamp to the voltage supply-line and the neutral supply-line, respectively, for operating the LED lamp.

13. The lampholder assembly according to claim 12, wherein the structural rejection feature includes a projection which extends from a face of the first lampholder.

14. The lampholder assembly according to claim 12, wherein the structural rejection feature is shaped so that when the first lampholder engages the first end of the LED lamp the structural rejection feature is positioned adjacent to the structural cooperating rejection feature.

15. The lampholder assembly according to claim 12, wherein the structural rejection feature is shaped as a curved lip.

16. The lampholder assembly according to claim 12, wherein the structural rejection feature has an upper face that is slanted downward from the structural cooperating feature when the first lampholder engages the first end of the LED lamp.

17. The lampholder assembly according to claim 12, wherein the structural rejection feature is shaped so the cooperating structural feature can be positioned to sit on or right above the structural rejection feature and rotated while in that position.

18. The lampholder assembly according to claim 15, wherein the curved lip has a first curvature that is larger than a second curvature of a face of the cooperating rejection feature that is positioned directly above the curved lip when the first lampholder engages the first end of the LED lamp.

19. The lampholder assembly according to claim 16, wherein the slanted upper face has a first slope that is substantially the same as a second slope of a face of the cooperating rejection feature that is positioned directly above the slanted upper face when the first lampholder engages the first end of the LED lamp.

20. An LED lamp comprising:
a housing provided with a first and second end;
a plurality of LED elements disposed within the housing; and
an electrical circuit electrically for coupling to the LED elements;
wherein the first end includes:
a first electrical connector adapted and configured to couple and electrically connect the electrical circuit to a voltage supply-line of a host electrical system via a first lampholder electrically connected to the voltage supply-line; and
a second electrical connector adapted and configured to couple and electrically connect the electrical circuit to a neutral supply-line of the host electrical system via the first lampholder, the second electrical connector being adapted and configured to prevent improper coupling to the voltage supply-line; and
wherein the second end includes:
a first plunger component adapted and configured to couple to a second lampholder, the first plunger component being adapted and configured to cooperate with a second plunger component provided on the second lampholder for biasing at least one of the first and second plunger components to generate a force for supporting the LED lamp in an installation position in which the first and second electrical connectors electrically connect the LED lamp to the voltage supply-line and the neutral supply-line, respectively, for operating the LED lamp;
wherein:
the LED lamp is adapted and configured to be engaged by the first lampholder only when the LED lamp is oriented in the installation position.

21. The LED lamp according to claim 20, wherein the first electrical connector has a first shape which is shaped for mating with a third electrical connector of the first lampholder that is electrically connected to the voltage supply-line; and wherein the second electrical connector has a second shape that is different than the first shape and which is shaped for mating with a fourth electrical connector of the first lampholder that is electrically connected to the neutral return-line; and
wherein the first and third electrical connectors and the second and fourth electrical connectors can only mate when the LED lamp is oriented in the installation position.
